(19) United States
(12) Patent Application Publication
(10) Pub. No.: US 2013/0191893 A1
(43) Pub. Date: Jul. 25, 2013

(54) System and Method for Ensuring Anonymity to Provide Self Help Guidance

(71) Applicants: Daniel J. Sutton, Portsmouth (GB); Paul S. Winter, Portsmouth (GB)

(72) Inventors: Daniel J. Sutton, Portsmouth (GB); Paul S. Winter, Portsmouth (GB)

(21) Appl. No.: 13/354,079

(22) Filed: Jan. 19, 2012

(51) Int. Cl. G06F 7/04

(52) U.S. Cl. 726/6

(57) ABSTRACT

User access to a help system is provided in an anonymous manner. A provider organization distributes unique pre-generated unique user access codes to potential users. The user access codes include a general information portion and a random portion. When accessing the system for the first time, the user enters their unique user access code, a username, and password. The system associates the username with the password and with the user access code. Subsequent, the user logs into the system using the username and password. Data may be compiled and stored in association with the user access code for later retrieval and analysis to calculate statistics for provider organizations.

### BACKGROUND

1. Field

Embodiments relate to providing assistance to users. More particularly, embodiments relate to providing a system through which users are encouraged to seek help via anonymous access to a motivation incentive system.

2. Background

Virtually everyone at some point during their lifetime has desired to seek assistance in one form or another. Oftentimes, these individuals would like to do so anonymously. For example, people are often hesitant to discuss their problems with others, or to go to seek help when issues involved are particularly sensitive either personally or professionally. As a result, people will often carry the issues unresolved with them, which can lead to emotional troubles, erratic behavior, depression, and a generally lower quality of life.

This reluctance to seek assistance with life problems is particularly acute with school children, who may face ridicule from peers and disappointment or judgment from parents if they divulge concerns or worries about their lives. In extreme cases, children have resorted to taking their own lives to escape real or perceived torment. Such hopelessness and senseless loss of life may have be averted if these children had a place to turn to find suggestions for helping them with their issues in a manner that would ensure their anonymity.

In addition to the problems associated with individual's reluctance to seek assistance to handle the issues they face, organizations that seek to offer help to troubled individuals would like to do so in a manner in which they can generate statistics associated with usage of the service they provide, while maintaining the anonymity of the users of the system. In this manner, those organizations can tailor their services to better assist those using their systems.

### SUMMARY

In embodiments, a system and method are provided that allow users to anonymously access a system from which they can obtain information, suggestions, and motivation for overcoming the issues they are facing. In embodiments, the system also provides information as to resources that are available for further assistance.

An embodiment is a system to provide anonymous help to a user. The system includes a processor, a memory, a display coupled to the processor, a registration page displayed on the screen that prompts a user to enter a pre-generated unique user access code that had previously been distributed to the user in an anonymous manner, a username, and a password, wherein the system receives the entered user access code, username, and password and stores the entered user access code, username and password in the memory such that the username is associated with the password and the entered user access code.

Another embodiment is a method for providing anonymous help to a user. The method includes distributing a pre-generated unique user access code to a user in an anonymous manner, displaying a registration page on a computer screen that prompts the user to enter the pre-generated unique user access code, a username, and a password, receiving the entered user access code, username, and password, and storing the entered user access code, username and password in a memory such that the username is associated with the password and the entered user access code.

Additional features and embodiments of the present invention will be evident in view of the following detailed description of the invention.

### BRIEF DESCRIPTION OF THE DRAWINGS

FIG. 1 is a schematic diagram of an exemplary computer 104 that can be configured to provide the client or server services described herein according to an embodiment of the present invention.

FIG. 2 is a schematic diagram illustrating connectivity of users and providers organizations according to an embodiment of the present invention.

FIG. 3 is a schematic illustration of a user access code according to an embodiment of the present invention.

FIG. 4 is an exemplary printed page that can be distributed to users of provide them with unique pre-generated user access codes according to an embodiment of the present invention.

FIG. 5 illustrates an exemplary user home page according to an embodiment of the present invention.

FIG. 6 illustrates an exemplary registration page according to an embodiment of the present invention.

FIG. 7 illustrates an exemplary login page according to an embodiment of the present invention.

FIG. 8A illustrates an exemplary home page according to an embodiment of the present invention.

FIG. 8B illustrates an exemplary help file selection page according to an embodiment of the present invention.

FIG. 8C illustrates an exemplary choice page according to an embodiment of the present invention.

FIG. 8D illustrates an exemplary user additional support page according to an embodiment of the present invention.

FIG. 9 illustrates an exemplary provider organization interface according to an embodiment of the present invention.

FIG. 10 is a flow chart for a process for registering a user according to an embodiment.

FIG. 11 is a flow chart for a method for providing statistics to a provider organization according to an embodiment.

### DETAILED DESCRIPTION

In embodiments, a system and method are provided that allow users to anonymously access a system from which they can obtain information, suggestions, and motivation for overcoming the issues they are facing. In embodiments, the system also provides information as to resources that are available for further assistance.

For example, an anonymous motivation system according to an embodiment allows a user to access help modules that the user can listen to, download, and/or read. In such embodiment, the help modules provide motivation to the user to obtain help they need to cope with their issues. In addition, the help modules can provide help to users for handling their issues.

In an embodiment, the service is provided through a web site interface that allows a user to create an account to anonymously access the service. Anonymity is maintained because a user enters a pre-generated user access code that is distinct from the identity of the user but still unique to the user. For example, a user access code can be distributed in a virtually random fashion to potential users of the system, which increases the anonymity of the potential users. To maintain anonymity, in an embodiment, a portion of the code is randomly generated. To generate and store statistics related to a particular organization offering the services described herein, a portion of the user access code stores identifying information for the organization.

When a user desires to use the system for the first time, the user enters the user's access code. The system then prompts the user to enter a username and password. The username and password entered by the user are linked or bound with the user's access code. Data pertaining to each session during which the user uses the system is obtained. The session data is linked or bound with the user's access code and stored. Session data from one or more users can be processed to provide statistics related to various levels, such as local, state, and national or other levels.

Subsequently, when the user uses the system, the user enters the user's username and password. This user's access code, which was previously linked or

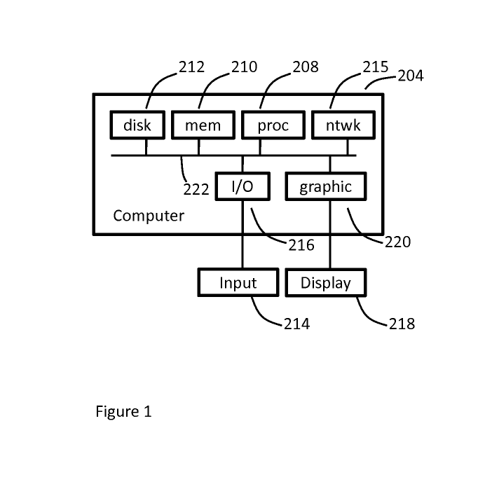

FIG. 1 is a schematic diagram of an exemplary computer 104 that can be configured to provide the client or server services described herein. In an embodiment, computer 104 includes a processor 108 to execute computer programs such as computer programs to carry out the operations described herein. Processor 108 can be any processor that can execute computer programs to carry out the operations described herein. Computer 104 includes a memory 110. In operation, memory 110 is loaded with a computer program to be executed by processor 108. Memory 110 can also store other data, such as scratch pad data and other to be used by processor 108 during its operation. Computer 104 is also coupled to a storage device 112. Storage device 112 can be internal and/or external to computer 104. Storage device 112 can be any internal or external storage including, for example, tape drive, CD-ROM, DVD, magnetic disk, or semiconductor disk. More than one storage device 112 can be present in a particular embodiment.

A bus 122 provides any required connectivity between processor 108, memory 110, and storage device 112. For example, data can be exchanged between processor 108, memory 110, and storage device 112 over bus 122. In an embodiment, computer 104 includes a network adapter 115. Network adapter 115 provides connectivity between computer 115 and other computers, for example, between a client user computer providing services to a user client and an organization server providing server services to the user client.

In an embodiment, computer 104 for a user may be implemented on a mobile device, such as a mobile telephone, computer tablet, personal digital assistant, or any other mobile communication device. For example, a mobile telephone may have executing thereon a mobile telephone application configured to provide the user with an interface for accessing the anonymous coaching system of an embodiment. Such computer 104 for a user as implemented on a mobile device may not have one or more of the components of computer 104 described with respect to FIG. 1.

An input device 114 is coupled to bus 122. In an embodiment, input device 114 is coupled to bus 122 through an input/output controller 116. Input device 114 can be a keyboard, a pointing device such as a mouse, or any other input device. More than one input device can be present in a particular embodiment. A display 118 is coupled to bus 122 through a graphics adapter 120. Display 118 is used to provide output to a user from computer 104.

In an embodiment computer 104 is connected to an external network 117. For example, in an embodiment, external network 117 can be the Internet, a telephone network, and/or other communication network. Connectivity to a telephone network can also be by way of telephone switching apparatus (not shown). Connectivity to external network 117 can be through any combination of wired and/or wireless interfaces appropriate to a particular embodiment, and may include intermediary servers, bridges, and and/or routers.

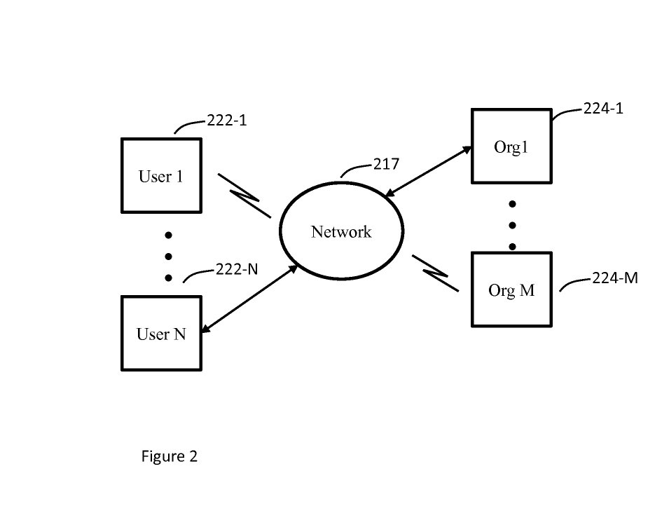

FIG. 2 is a schematic diagram illustrating connectivity of users 222-1 through 222-N and provider organizations 224-1 through 224-M. Connectivity is provided over a network 216. Network 216 can be any network or combination of networks. For example, network 216 can be the Internet, an intranet, a telephone network, a wide area network (WAN), a local area network (LAN), or any combination thereof. Note that the user and/or provider organizations can be connected wirelessly over an air interface as well as wired. In an embodiment, any combination of wired and wireless connectivity can be used to provide communication between provider organization computers, and user computers.

Provider organization can be any entities that desire to offer services to a group or groups of users. For example, provider organization can be schools, school organization, retail chains and stores, health care providers, or any other entity desiring to offer services to a group or groups of users.

In operation, to maintain anonymity for users desiring to use a system according to an embodiment, potential users are provided with a pre-generated user access code. The pre-generated user access code does not in any way identify any particular potential user to which it is provided. Instead, the pre-generated user access code provides sufficient information so that when a user uses the system, data pertaining the user's use can be collected and stored. The stored data can be provided to provider organization so that they can monitor in general what users are interested in. This will help the provider organizations tailor the system to fit the needs of their users without requiring information that identifies any particular user. No identifying information concerning the user is maintained.

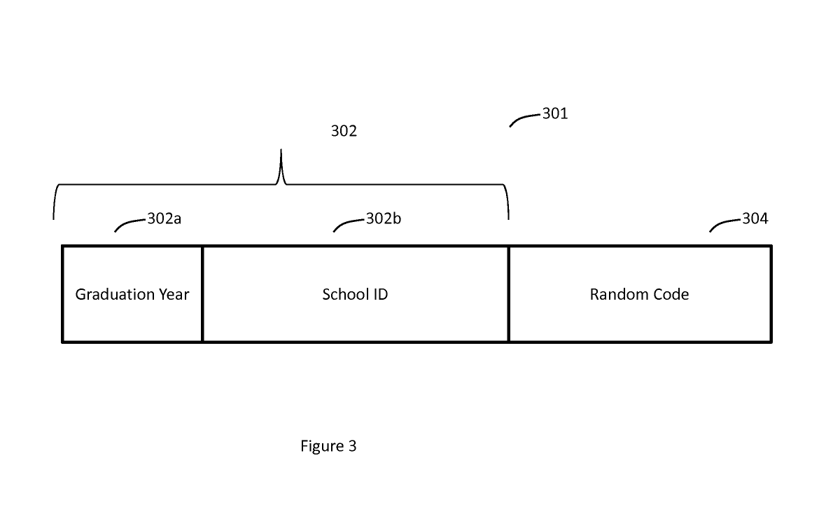

FIG. 3 is a schematic illustration of a user access code 301 according to an embodiment. As shown in FIG. 3, in an embodiment, a user access code includes a general information portion 302 and a random portion 304. General information portion 302 contains stores general information about users and provider organizations of which they are members. According to an embodiment, information contained in general information portion 302 doe not identify any particular user. Random portion 304 is used to distinguish different users using the system without compromising the identity of any particular user. In an embodiment, random portion 304 is generated using a random (or pseudo random) number generator. The range of numbers from which the randomly (or pseudo randomly) generated number is generated must be large enough so that a unique number can be assigned to each user for which general information portion 302 is the same.

As an example, FIG. 3 illustrates an exemplary user access code 301 where the provider organization is a school and the user is a student in the school. In exemplary user access code 301, general information portion 302 includes information identifying the school and general aspects of the user that the user attends. In the example of FIG. 3, this information is included in two (2) fields, 302a and 302b. Field 302a stores a code that identifies a particular school, the state in which the school is located, and the district in which the school is located. Any other information can be included in addition to, or in lieu of, the information illustrated in FIG. 3. The one caveat is that the information stored cannot identify any particular user (for example, a particular student in the case of exemplary user access code 301) of the system. Random portion 304 is a unique number that is generated for each user (for example, each student in the case of exemplary user access code 301) for which general information portion 302 is the same.

The user access code can be any length required to hold general information portion 302 and random portion 304. For further security, the user access code can be encrypted. Any appropriate encryption technique can be used.

Generation of unique user access codes in this manner also allow verification of access codes when users enter them. For example, each user access code that is generated can be stored in a master user access code list. When a user enters a user access code to begin the registration process to access the system, the system can check the entered user access code against the master list of user access codes. If there is a match, the user is allowed to continue. If there is no match, the user is so informed and asked to re-enter the user's user access code. If the access codes are encrypted for distribution to potential users, the entered user access code can be decrypted prior to comparison.

In operation, unique user access codes are pre-generated to be distributed to potential users of a provider organization's service. Distribution of the pre-generated unique user access codes can be by any way of providing the pre-generated user access codes to potential users such that each potential user is provided a unique pre-generated user access code. For example, the pre-generated unique user access codes can be printed on paper and distributed via hand, mail, fax, email, or other method to potential users. Any method of distributing pre-generated unique user access codes to potential users can be employed. In an embodiment, for example, the pre-generated unique user access codes may be distributed to potential users in a meeting or assembly. Distribution of the pre-generated unique user access codes without pre-determining which potential user receives which pre-generated unique user access code.

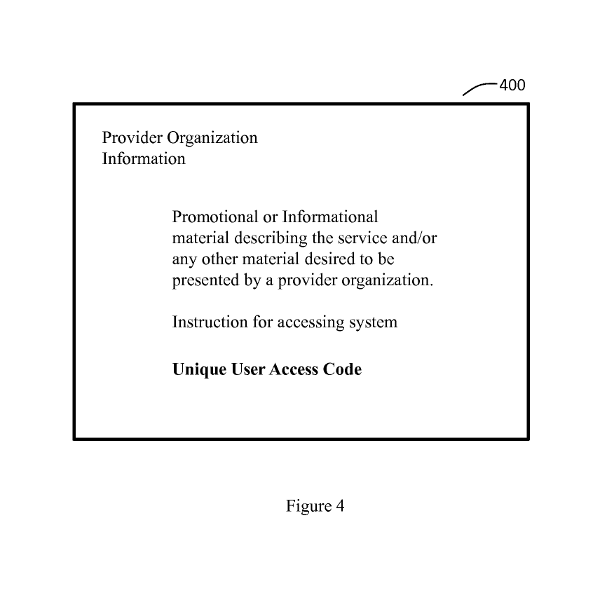

FIG. 4 is an exemplary printed page 400 that can be distributed to users of provide them with unique pre-generated user access codes. As shown in FIG. 4, exemplary page 400 includes identification of the provider organization, promotional and/or information material, instructions for accessing the provider organization's system, and a unique pre-generated user access code. Exemplary page 400 can be tailored to provide any content a provider organization desires to provide its users.

Pre-generated user access codes can also be distributed via email, fob, text, or any other way of distributing the pre-generated user access codes such that each potential user is provided a unique user access code to access the system provided by the provider organization. Regardless of technique used to distribute pre-generated user access codes to users, the distribution can include any other information desired by the provider organization. For example, as described above, the distribution can include identification of the provider organization, promotional material, information material, and or instructions for accessing the provider organization system.

The process for pre-generating the user access code and distribution to potential users can be performed by or on behalf of a provider organization. For example, a provider organization can use the services of a third party to create and distribute pre-generated user access codes.

A user desiring to access a provider organization's system for the first time proceeds to an access point of the provider organization's system. For example, the user surfs to the provider organization's home page. Once at the provider organization's home page (or other access point), the user selects a registration option. The registration option causes the user to be prompted to enter the user's unique user access code. As described above, the user's unique access code is the unique pre-generated access code that was previously distributed to the user. After the user enters the user's unique user access code, the user is prompted to enter a username and password. To maintain anonymity, the user is instructed to provide a username that has no identifying information.

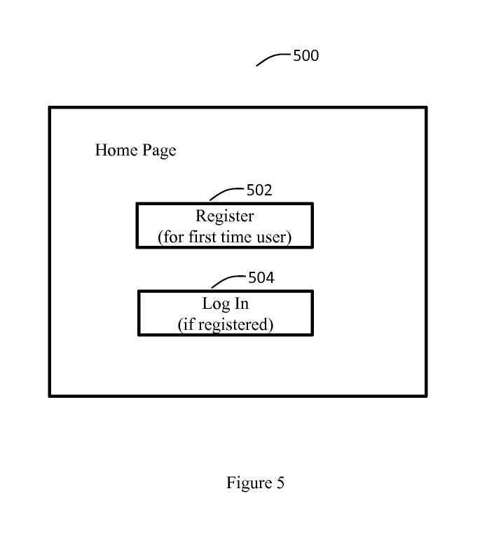

FIG. 5 illustrates an exemplary user home page 500 according to an embodiment. As shown in FIG. 5, home page 500 includes a registration button 502 and a log in button 504. When the user presses registration button 503, the user is forwarded to a registration page. When the user presses registration button 504, the user is forwarded to a log in page.

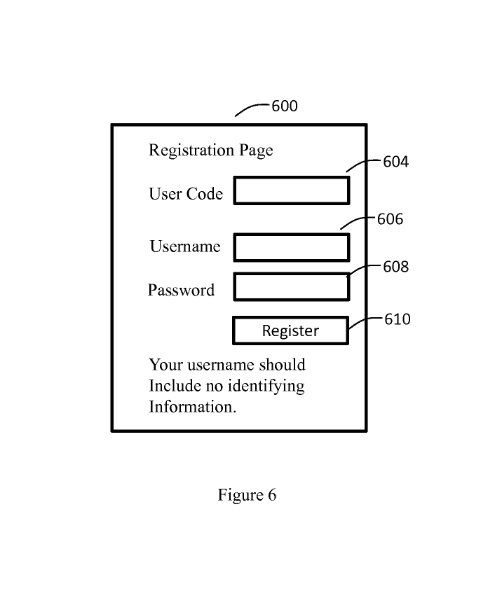

FIG. 6 illustrates an exemplary registration page interface 600 according to an embodiment. As shown in FIG. 6, exemplary registration page 600 includes text boxes for entering the user's user access code, a username, and a password. The user enters the required information and presses register button 610. Upon pressing register button 610, the entered username and password are stored such that they are associated with one another. In addition, the entered username is stored so as to be associated with the user's unique user code. In this manner, data compiled in association with the user's username for each session involving the user can be associated with the user without requiring information that could be used to identify the user.

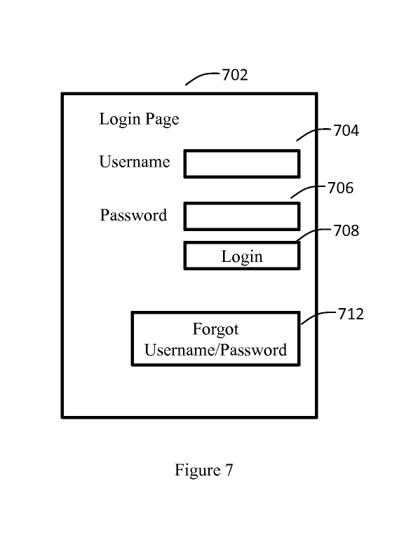

FIG. 7 illustrates an exemplary login page 702 according to an embodiment. Login page 702 provides access to the help functions of the provider organization system. In an embodiment, a user logs in entering the user's username in username field 704 and entering its password in password field 706. Once entered, the user selects a login button 708 to access the system. For example, in an embodiment, selection is performed by using a pointing device such as a mouse and clicking on login button 708 in a well known manner. If the entered information matches username and password information previously stored during registration for the user, the user is provided access to the system and is directed to a user home page (described below). If the entered information does not so match, the user is so advised, and requested to re-enter the information.

If the user forgot his or her username or password, the provider organization selects forgot username/password button 712 in login page 702. Upon selecting forgot username/password button 712, the user is instructed to obtain a new unique user access code from their provider organization. This helps to protect the anonymity of the user.

In an alternate embodiment, a user can access the system by entering the user's unique access code and password that is associated with the user's username. The system verifies the entered password matches the password associated with the user's username. If there is a match, the user is directed to a user home page. If there is no match, the user is so advised, and requested to re-enter the information.

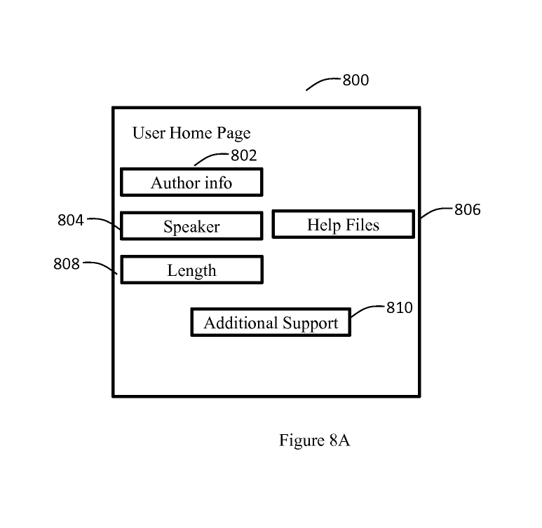

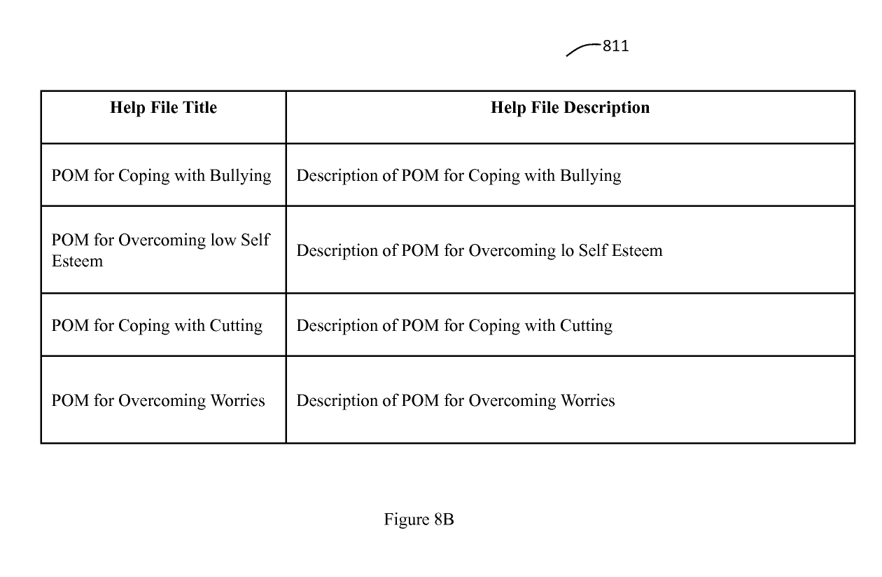

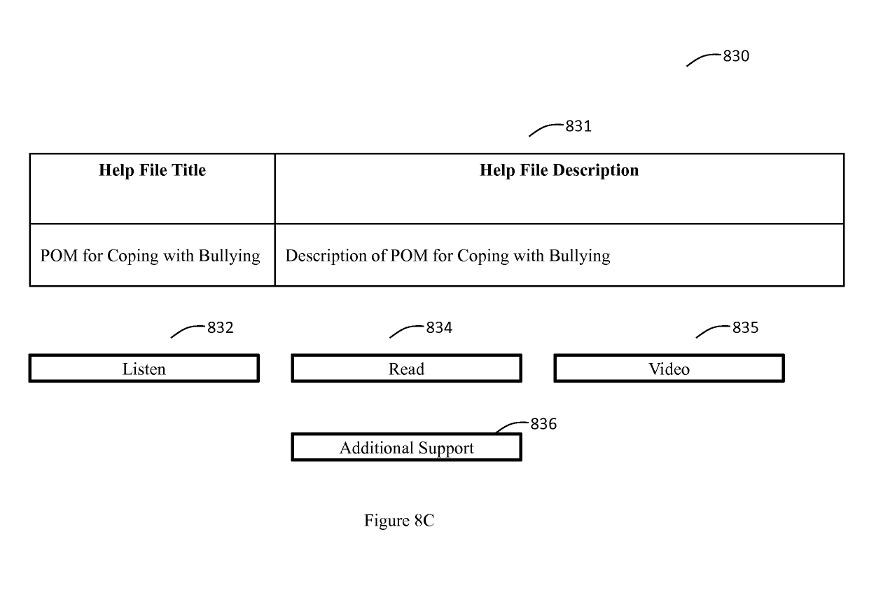

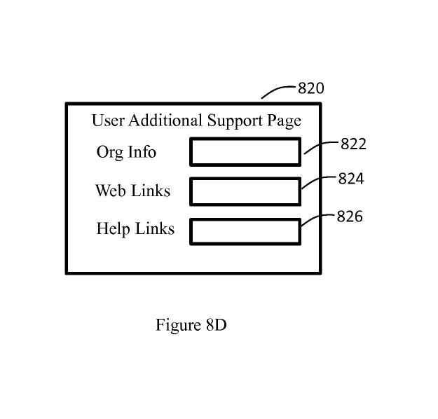

FIG. 8A illustrates an exemplary home page 800 according to an embodiment. When the user accesses user home page 800, he or she is provided a number of choices. In an embodiment, for example, these choices include seeing information about the author(s) of the content the user wishes to listen to by selecting author information button 802, providing a list of help files concerning various topics the user may be interested in learning about by selecting help files by selecting button 806, choosing to listen to a particular help file by selecting speaker button 804, finding out the length of a particular title by selecting length button 808, and obtaining additional support by selecting additional support button 810. In an embodiment, there is no browser history maintained of the web pages visited by the user during a user session.

FIG. 8B illustrates an exemplary user help file selection page 811 that may be displayed upon a user selecting button 806 in home page 800 according to an embodiment. User help file selection page 811 includes a list of help files and a description associated with each help file. When the user selects a particular help file, the user is provided with a set of choices for accessing the help file. For example, in an embodiment, the user can choose to listen to a recording of the help file, read a file containing the help file (for example, as a flipbook presentation), or view a video of the help file. This set of choices can be provided to the user by navigating the user to another web page that contains the set of choices, providing a set of radio buttons from which the user can select a choice, providing a drop down menu with the set of choices, or any other method for providing a selectable set of choices to the user.

FIG. 8C illustrates an exemplary choice page 830 for providing a set of choices to the user to select from to access a particular help file the user selected from exemplary user help file selection page 811. As shown in FIG. 8C, choice page 830 includes a table 831 that identifies the selected help file and provides its description. The user can select to listen to a recording of the help file by selecting button 832. The user can select to read the help file by selecting button 834. The user can select to view a video of the help file by selecting button 835.

In an embodiment, when a user makes a selection, the selection, for example, identification of the recording or read file selected, is associated with the user's user access code. Other selections, such as requests for additional support can also be associated with the user's user access code. In this manner, the user's selection is collected as part of the user's session data to be used to generate statistics for provider organizations as described in more detail below.

In an embodiment, the set of choices provides an option for the user to obtain additional support to consult to obtain additional information related to their issue. To obtain additional support, the user selects additional support button 836 on exemplary choice page 830 in FIG. 8C. When the user selects the choice to obtain additional support, the user is directed to a user additional support page.

FIG. 8D illustrates an exemplary user additional support page 820 according to an embodiment. Additional support page 820 includes a button 822, which the user selects to obtain information concerning additional support from the organization of which the user is part of the user base. For example, the user might obtain information related to psychiatric assistance, guidance counselors, or other organization-offered resources. For example, in a school setting, a student can be provided an anonymous, secure, encrypted connection to a school guidance counselor to obtain additional help with an issue. The user can obtain links to websites that may be of interest by selecting button 824. Further help resources can be obtained by selecting button 826.

When the user is finished with a particular session, the user logs off the system. When the user desires to use the system again, the user accesses, the provider organization's access point. This time, however, rather than select a registration option, the user selects a log in option. The log in option causes the user to be prompted to enter the username and password that the user entered during the registration period. Once authenticated, the user is provided access to the provider organization's system.

During each user session, the provider organization system collects data related to the user session. The collected data can be processed or analyzed by the provider organization for a number of reasons, including determining what issues are of most concern or importance to their users, how much users are using the system, when users are using the system, and any other statistics, the provider organization may desire.

Data collected during user sessions can be provided to a provider organization through a statistics interface. The data is collected each time a user accesses the system using the user's username and password. To correlate the collected data with a particular user, the user access code associated with the username is obtained. Any user session data calculated during the user session are stored in association with the user access code.

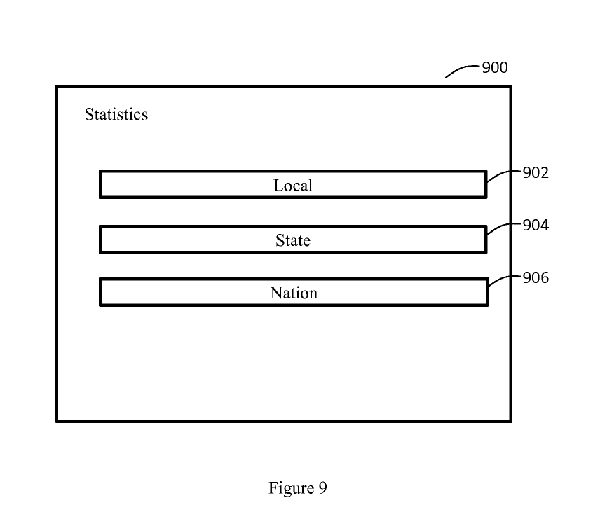

FIG. 9 illustrates an exemplary statistics interface 900 according to an embodiment. Statistics interface 900 provides a provider organization the ability to select to view a number of statistics concerning usage by its users. Any relevant statistics can be generated and provided for viewing using statistics interface 900.

In embodiments, statistics can be provided at various levels. For example, statistics can be provided at entity, local, district, region, state, national and any other level. In an embodiment, access to statistics at the various levels can be limited to particular provider organizations depending on the level of the provider organization. For example, a local school may be provided access to statistics at the school level, but not at the district, state, or national levels.

For example, using exemplary statistics interface 900, to obtain local statistics, local button 902 is selected, to obtain statewide statistics, state button 906 is selected, to obtain nationwide statistics, nation button 906 is selected. If a provider organization is not to have access to a particular level, the level can be grayed out, not included or otherwise inactivated. In an embodiment, selecting one of buttons 902, 904, or 906 causes another display to be presented that has choices as to which particular statistics are available. Exemplary statistics for a schools-based embodiments are described below.

An exemplary embodiment for statistics related to offering help to students is described. In such embodiment, the provider organizations are school organizations, statistics related to students' use of the system can be calculated and provided to the school organizations. In the embodiment, statistics can be calculated for the school, district, state, and national levels.

In the exemplary embodiment, statistics calculated at the school level include statistics calculated per year per group (for example grade level) and for the school.

In the exemplary embodiment, statistics calculated at the district level include statistics calculated per year per group (for example grade level) per school, per year per group for the district, per school for the district, and for the district. In embodiments, other statistics can be included at the district level as required by the particular embodiment.

In the exemplary embodiment, statistics calculated at the state level include statistics calculated per year per group (for example grade level) per school, per year per group per district, per year per group for the state, per school per district, per school for the state, per district for the state, and for the state. In embodiments, other statistics can be included as required by the particular embodiment.

In the exemplary embodiment, statistics calculated at the national level include statistics calculated per year per group (for example grade level) per school, per year per group per district, per year per group per state, per year per group for the country, per school per district, per school per state, per district per state, per school for the country, and for the country. In embodiments, other statistics can be included as required by the particular embodiment.

In the exemplary school embodiment available statistics include number of user access codes used, number of flipbooks (readings) and/or recordings opened and/or downloaded, number of times each flipbook (reading) and/or recording is opened and/or downloaded, and the number of times the site is visited. These statistics are available at the school, district, state, and national levels as described above. Any other statistics that are of interest in a particular environment, while still maintaining anonymity, can be accumulated.

To generate the level statistics, the system processes the data stored for each user session. For example, to obtain state level statistics, the system obtains all data associated with a user access codes that have state information in general information 302 in the user access codes that corresponds to the state of interest. The obtained data is then accumulated to obtain the desired state level information. Other level statistics are calculated in a similar manner.

One or more data structures and/or databases can be used to store the information described above. The information stored in the data structures and/or databases can also be store more permanently or semi-permanently in, for example, a hard disk drive.

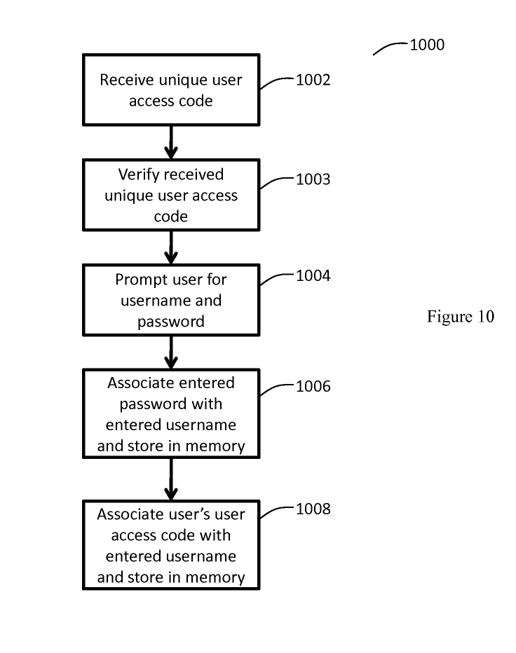

FIG. 10 is a flow chart 1000 for a process for registering a user according to an embodiment. In step 1002, the system receives a user's unique user access code. In an embodiment, the received unique user access code is a pre-generated user access code that has been generated and distributed as described above. In step 1003, the system verifies the received user access code. This can be accomplished by comparison with a master list of access codes as described above. If the access codes were encrypted for distribution to potential users, the received user access code can be decrypted prior to verification. In step 1004, a user is prompted for a use and password. In step 1006, the entered username and password are associated with one another and stored in memory. In step 1008, the entered username is associated with the received unique user access code and stored in memory.

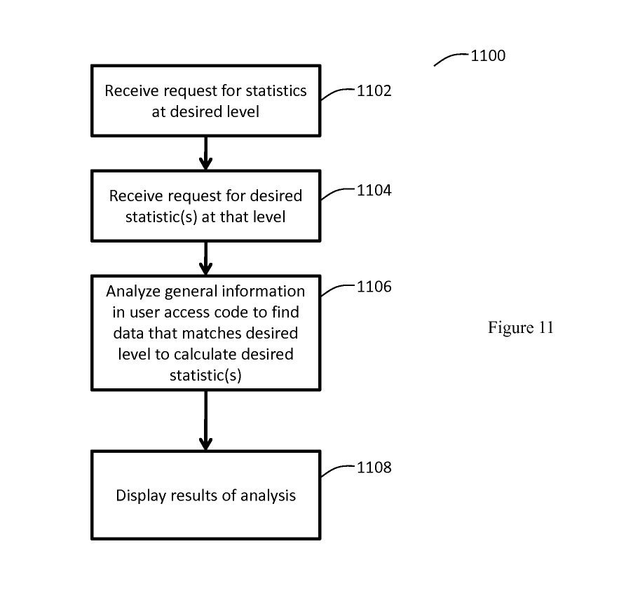

FIG. 11 is a flow chart for a method for providing statistics to a provider organization according to an embodiment. In step 1102, the system receives a request for statistics at a desired level. For example, in an embodiment, the level may be the state level. In step 1104, the system receives a request for desired statistics at that level. For example, in an embodiment, the provider organization may be interested in the number of times a particular recording was accessed at by the schools in a particular state. In an embodiment, more than one statistic can be selected. In step 1106, general information in user access codes is analyzed to determine relevant user session data. Relevant user session data is that user session data that is used to calculate the desired statistic(s). For example, where the provider organization desires the number of times a particular recording was accessed by the schools in a particular state, the user access codes associated with the particular recording are analyzed to determine those user access codes that have general information that matches the desired state and school. The number of such user access codes is determined to calculate the desired statistic. Other statistics can be calculated using the collected user session data along with general information in the user access codes. In step 1108, the results of the analysis are displayed.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system to provide anonymous help to a user, comprising:
a processor;
a memory;
a display coupled to the processor;
a registration page displayed on the screen that prompts a user to enter a pre-generated unique user access code that had previously been distributed to the user in an anonymous manner, a username, and a password, wherein the system receives the entered user access code, username, and password and stores the entered user access code, username and password in the memory such that the username is associated with the password and the entered user access code.

2. The system of claim 1, wherein the system verifies the user access code.

3. The system of claim 1, wherein the system collects and stores data related to a user's use of the system in an anonymous manner.

4. The system of claim 1, wherein the pre-generated unique user access code includes a general information portion and a random portion.

5. The system of claim 1, wherein data for each of a plurality of user sessions is collected and associated with a corresponding one of a plurality of pre-generated unique user access codes.

6. The system of claim 5, wherein statistics are derived from analysis of collected data associated with the plurality of pre-generated unique user access code.

7. The system of claim 5, wherein the statistics are derived in accordance with general information contained in each of the plurality of pre-generated unique user access codes.

8. The system of claim 1, wherein the system is a school-based system, and the pre-generated access code includes a general information portion that contains information about a school and the year of graduation of a student, and a random portion that contains a random number corresponding to the student, wherein use of the pre-generated unique user access code maintains anonymity of the student.

9. The system of claim 1, wherein after registration, the user is able to access the system using the entered username and password.

10. A method for providing anonymous help to a user, comprising:
distributing a pre-generated unique user access code to a user in an anonymous manner;
displaying a registration page on a computer screen that prompts the user to enter the pre-generated unique user access code, a username, and a password;
receiving the entered user access code, username, and password; and
storing the entered user access code, username and password in a memory such that the username is associated with the password and the entered user access code.

11. The method of claim 10, further comprising verifying the user access code.

12. The method of claim 10, further comprising:
collecting data related to a the user's use of the system in an anonymous manner; and
storing the collected data.

13. The method of claim 10, wherein the pre-generated unique user access code includes a general information portion and a random portion.

14. The method of claim 10, further comprising:
collecting data for each of a plurality of user sessions, each user session associated with a corresponding pre-generated user access code; and
associating the collected data with the corresponding pre-generated unique user access code.

15. The method of claim 14, further comprising deriving statistics from analysis of the data associated with the plurality of pre-generated unique user access codes.

16. The method of claim 14, further comprising deriving the statistics in accordance with general information contained in each of the plurality of pre-generated unique user access codes.

17. The method of claim 10, wherein the pre-generated unique user access code corresponds to a school system, and wherein the pre-generated unique user access code includes a general information portion that contains information about a school and the year of graduation of a student, and a random portion that contains a random number corresponding to the student, and wherein use of the pre-generated unique user access code maintains anonymity of the student.

18. The method of claim 10, wherein after registration, the user is able to access the system using the entered username and password.

19. The method of claim 10, further comprising printing the pre-generated unique user access code, and distributing the pre-generated unique user access code by one of mail, email, handout, and facsimile.

20. The method of claim 10, further comprising distributing the pre-generated unique user access code to a plurality of users without pre-determining which user gets which pre-generated unique user access code.
